(19) United States
(12) Patent Application Publication
(10) Pub. No.: US 2020/0150937 A1
(43) Pub. Date: May 14, 2020

(54) ADVANCED MACHINE LEARNING INTERFACES

(71) Applicant: Manhattan Engineering Incorporated, San Francisco, CA (US)

(72) Inventors: Adam Smith, San Francisco, CA (US); Tarak Upadhyaya, San Francisco, CA (US); Juan Lozano, San Francisco, CA (US); Daniel Hung, San Francisco, CA (US)

(21) Appl. No.: 16/680,047

(22) Filed: Nov. 11, 2019

Related U.S. Application Data
(60) Provisional application No. 62/758,499, filed on Nov. 9, 2018.

(51) Int. Cl. G06F 8/38; G06F 8/34; G06F 17/27; G06N 20/00; G06N 3/02

(52) U.S. Cl. CPC G06F 8/38; G06F 8/34; G06N 3/02; G06N 20/00; G06F 17/2705

(57) ABSTRACT

A smart assistant is disclosed that provides for interfaces to capture requirements for a technical assistance request and then execute actions responsive to the technical assistance request. Example embodiments relate to parsing natural language input defining a technical assistance request to determine a series of instructions responsive to the technical assistance request. The smart assistant may also automatically detect a condition and generate a technical assistance request responsive to the condition.

### CROSS-REFERENCE TO RELATED APPLICATIONS

This application claims the benefit of U.S. Provisional Patent Application No. 62/758,499, filed Nov. 9, 2018, which is hereby incorporated by reference in its entirety.

### FIELD OF INVENTION

The present disclosure relates generally to methods and systems for advanced machine learning interfaces.

### BACKGROUND

Many computer-based tasks may be beyond the capabilities of many users. To accomplish these tasks, many people may rely on the assistance of a technical coworker such as a computer programmer. However, many of these tasks that require a technical coworker may be routine, repetitive, or mundane for the technical coworker to perform. This creates a pain point for both the non-technical coworker and the technical coworker. The non-technical coworker is blocked until the technical coworker completes the task, and the technical coworker finds the task undesirable because it is repetitive.

Technical users also encounter repetitive technical tasks in their daily workflow. These repetitive and monotonous tasks may similarly slow down a technical user, preventing them from working on more challenging or important tasks.

### SUMMARY

A smart assistant is disclosed that provides for interfaces to capture requirements for a technical assistance request and then execute actions responsive to the technical assistance request. Example embodiments relate to parsing natural language input defining a technical assistance request to determine a series of instructions responsive to the technical assistance request. The smart assistant may also automatically detect a condition and generate a technical assistance request responsive to the condition. One or more driver applications may control or command one or more computing systems to respond to the technical assistance request.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a computer-implemented method including: displaying, by a computer system, a user interface element for receiving a technical assistance request from a user. The computer-implemented method also includes receiving, by the computer system, the technical assistance request. The computer-implemented method also includes analyzing, by a translator, the technical assistance request to determine an intent of the user. The computer-implemented method also includes generating, by the translator, a sequence of instructions responsive to the intent of the user. Other embodiments of this aspect include corresponding computer systems, apparatus, and computer programs recorded on one or more computer storage devices, each configured to perform the actions of the methods.

Implementations may include one or more of the following features. The computer-implemented method further including performing, by a driver application, the sequence of instructions, where the driver application controls the execution of at least one computer applications, where the at least one computer applications are not the translator and not the driver application. The computer-implemented method where the sequence of instructions responsive to the intent of the user is a sequence of computer instructions expressed in a programming language. The computer-implemented method further including: receiving the technical assistance request in the form of natural language text. The computer-implemented method may also include parsing, by a parser, the technical assistance request into tokens. The computer-implemented method may also include determining the intent of the user from the parsed technical assistance request using a machine learning model. The computer-implemented method where the machine learning model is a neural network. The computer-implemented method where the user interface element is a graphical user interface (GUI) request builder, where the GUI request builder includes a plurality of visible interface elements for building the technical assistance request. The computer-implemented method further including: receiving the technical assistance request in the form of an image. The computer-implemented method may also include parsing, by a parser, the technical assistance request into tokens. Parsing the technical assistance request into tokens may be performed on textual components of the technical assistance request. Optionally, the technical assistance request may comprise an image. The image may be analyzed by an image analysis algorithm and one or more features or components extracted. The computer-implemented method may also include determining the intent of the user from the parsed technical assistance request, or analyzed image, using a machine learning model. The computer-implemented method further including: receiving the technical assistance request in the form of natural language text. The computer-implemented method may also include parsing, by a parser, the technical assistance request into tokens. The computer-implemented method may also include analyzing the parsed technical assistance request with a machine learning model and detecting a need for additional information. The computer-implemented method may also include generating an information request. The computer-implemented method may also include displaying the information request to the user. The computer-implemented method may also include receiving additional information from the user. The computer-implemented method may also include parsing, by the parser, the additional information into tokens. The computer-implemented method may also include analyzing the parsed additional information with the machine learning model. The computer-implemented method may also include determining the intent of the user from the parsed technical assistance request and the parsed additional information using the machine learning model. The computer-implemented method where the driver application controls the execution of the at least one computer applications by using application programming interfaces (APIs) of the at least one computer applications. The computer-implemented method further including: where the technical assistance request is a request to query a database. The computer-implemented method may also include automatically generating a sequence of queries to access the database according to the technical assistance request. The computer-implemented method further including: where the technical assistance request is a request to generate markup language source code from a design mock up. The computer-implemented method may also include analyzing the design mock up using a machine learning model. The computer-implemented method may also include generating by the machine learning model the markup language source code for the design mock up. Implementations of the described techniques may include hardware, a method or process, or computer software on a computer-accessible medium.

One general aspect includes a computer-implemented method including: monitoring, by a computer system, user actions, where the user actions include at least an edit action, navigate action, or select action. The computer-implemented method also includes analyzing the user actions using a machine learning model. The computer-implemented method also includes determining, by the machine learning model based on the user actions, that the user is in need of technical assistance. The computer-implemented method also includes determining a type of technical assistance needed by the user. The computer-implemented method also includes generating, by a translator, a sequence of instructions responsive to the type of technical assistance needed by the user. The computer-implemented method also includes performing, by a driver application, the sequence of instructions, where the driver application controls the execution of at least one computer applications, where the at least one computer applications are not the translator and not the driver application. Other embodiments of this aspect include corresponding computer systems, apparatus, and computer programs recorded on one or more computer storage devices, each configured to perform the actions of the methods.

Implementations may include one or more of the following features. The computer-implemented method further including displaying a message to the user to ask if he needs technical assistance, prior to performing the sequence of instructions. The computer-implemented method further including prompting the user for input about the type of technical assistance needed. The computer-implemented method where the technical assistance request is a request to configure a computer environment, and the driver application configures the computer environment according to the technical assistance request. The computer-implemented method further including: where the technical assistance request is a request to query a database. The computer-implemented method may also include automatically generating a sequence of queries to access the database according to the technical assistance request. The computer-implemented method where the driver application controls the execution of the at least one computer applications by using application programming interfaces (APIs) of the at least one computer applications. The computer-implemented method where the driver application controls the execution of the at least one computer applications by using a machine learning-based driver, where the machine learning-based driver is a machine learning model trained on prior uses of the at least one computer applications, the prior uses including video frames of prior uses of the at least one computer applications. The computer-implemented method where the driver application controls the execution of the at least one computer applications by mimicking human input. Implementations of the described techniques may include hardware, a method or process, or computer software on a computer-accessible medium.

One general aspect includes a computer-implemented method including: displaying, by a computer system, a user interface element for receiving technical assistance requests. The computer-implemented method also includes receiving, by the computer system, a technical assistance request to generate code. The computer-implemented method also includes analyzing, by a translator, the technical assistance request to determine an intent of the user. The computer-implemented method also includes generating, by the translator, a sequence of instructions in a computer language responsive to the intent of the user. Other embodiments of this aspect include corresponding computer systems, apparatus, and computer programs recorded on one or more computer storage devices, each configured to perform the actions of the methods.

Implementations may include one or more of the following features. The computer-implemented method where the technical assistance request is in the form of pseudocode. The computer-implemented method where the technical assistance request is in the form of natural language text. The computer-implemented method where the technical assistance request is in the form of a set of graphical elements. Implementations of the described techniques may include hardware, a method or process, or computer software on a computer-accessible medium.

### BRIEF DESCRIPTION OF THE DRAWINGS

The present disclosure will become better understood from the detailed description and the drawings, wherein:

FIG. 1 is a block diagram illustrating an exemplary network environment that may be used in an embodiment;

FIG. 2A illustrates an exemplary machine learning model;

FIG. 2B illustrates use of the machine learning model to perform inference on input comprising data relevant to a programming co-pilot system;

FIG. 3 illustrates an exemplary system for software development;

FIG. 4 illustrates the steps of a method for automating a technical assistance request task according to an embodiment;

FIGS. 5A-B illustrate the steps of a method for translating natural language text into a technical assistance request according to an embodiment;

FIG. 6 illustrates the steps of a method for defining a technical assistance request by a request builder to arrange form elements according to an embodiment;

FIG. 7 illustrates the steps of a method for automatically performing a technical assistance request task according to an embodiment;

FIG. 8 illustrates the steps of a method for generating computer code from natural language text according to an embodiment;

FIG. 9 illustrates the steps of a method for automatically generating a sequence of queries to access a database according to an embodiment;

FIG. 10A illustrates the steps of a method for generating a graphical user interface from a mockup according to an embodiment;

FIG. 10B illustrates the steps of a method for generating computer code from a high-level or natural language description according to an embodiment;

FIG. 10C illustrates the steps of a method for translating computer code into a higher-level representation, receiving edits to the higher-level representation, and translating back into computer code according to an embodiment; and

FIG. 11 illustrates an example machine of a computer system within which a set of instructions, for causing the machine to perform any one or more of the methodologies discussed herein, may be executed.

### DETAILED DESCRIPTION

In this specification, reference is made in detail to specific embodiments of the invention. Some of the embodiments or their aspects are illustrated in the drawings.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein.

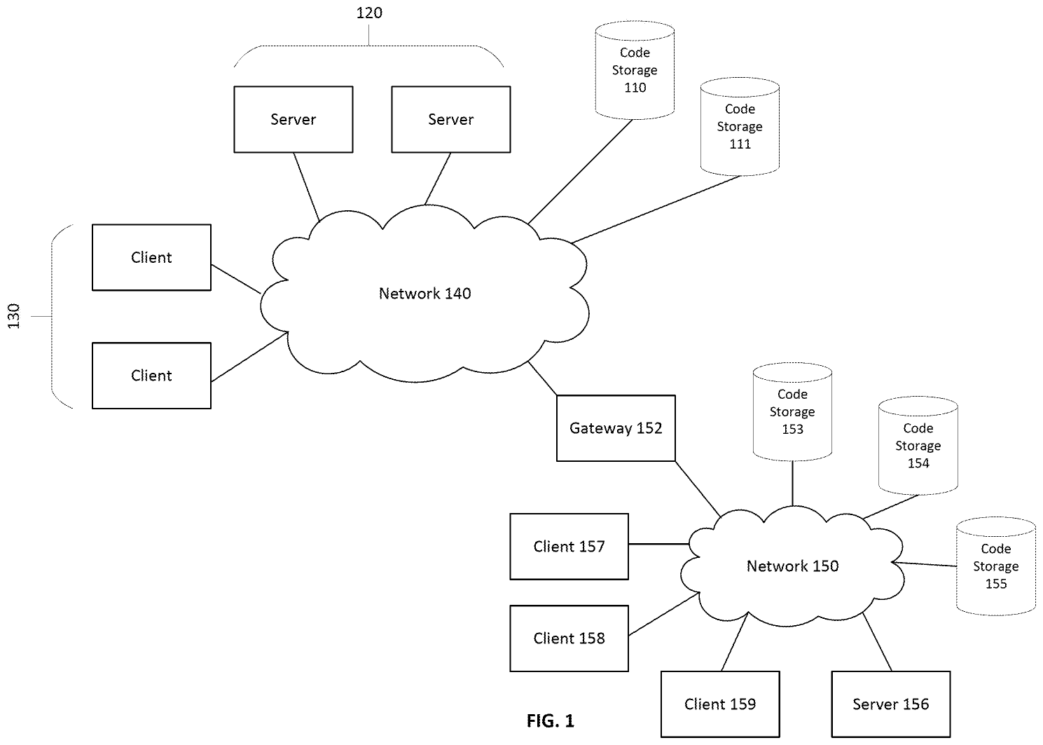

FIG. 1 is a block diagram illustrating an exemplary network environment that may be used in an embodiment. The network environment may include one or more clients and servers connected via a network 140. The network 140 may include a local area network (LAN), a wide area network (WAN), a telephone network, such as the Public Switched Telephone Network (PSTN), an intranet, the Internet, or a combination of networks. The network may include external code storage 110, 111 that store computer code, such as source code. Some external code storage 110, 111 may be globally accessible to any entity on the network 140. Other external code storage 110, 111 may be private and require login-in and authentication to access. The network 140 may include various entities such as servers 120 and clients 130.

Local network 150 may connect to network 140 through gateway 152. In some embodiments, the local network 150 may be private and access controlled so that entities on the network 140 cannot generally access the resources on local network 140. However, entities on the local network 150 may access and share at least some of the resources on the local network 150. Code storage 153 may comprise code stored on the local network 150 after having been web scraped from external code sources 110, 111. Code storage 154 may exist on the local network 150 and may store code from a team of programmers working from clients 157, 158, 159 on the local network 150. In an embodiment, a code storage 155 is an individual code storage that stores code of just one of the programmers on the team. The code storage 155 may be separate from code storage 154 or may be, for example, a subset of code storage 154. Code storage may be any kind of storage. In some embodiments, a code storage may comprise a codebase, which is a collection of code for building one or a set of software systems, applications, or software components. Moreover, in some embodiments, a codebase comprises a code repository, where a repository keeps track of changes in the codebase over time and may allow version control and allowing checking in and checking out of code. In some embodiments, code storage comprises a database. A database is any kind of storage and no particular type of database is required. For example, a database may comprise storage of files in memory or permanent storage. Server 156 may exist on the local network 150 and run a program comprised of code from the team of programmers. The code may be team code stored in code storage 154 or an individual branch or subset stored on code storage 155. Server 156 may generate logs or output during the execution of the program, and the logs or output may be retrieved by clients 157, 158, 159 for monitoring or debugging of the program.

Additional servers, clients, computer systems, and local networks may be connected to network 140. It should be understood that where the terms server, client, or computer system are used, this includes the use of networked arrangements of multiple devices operating as a server, client, or computer system. For example, distributed or parallel computing may be used.

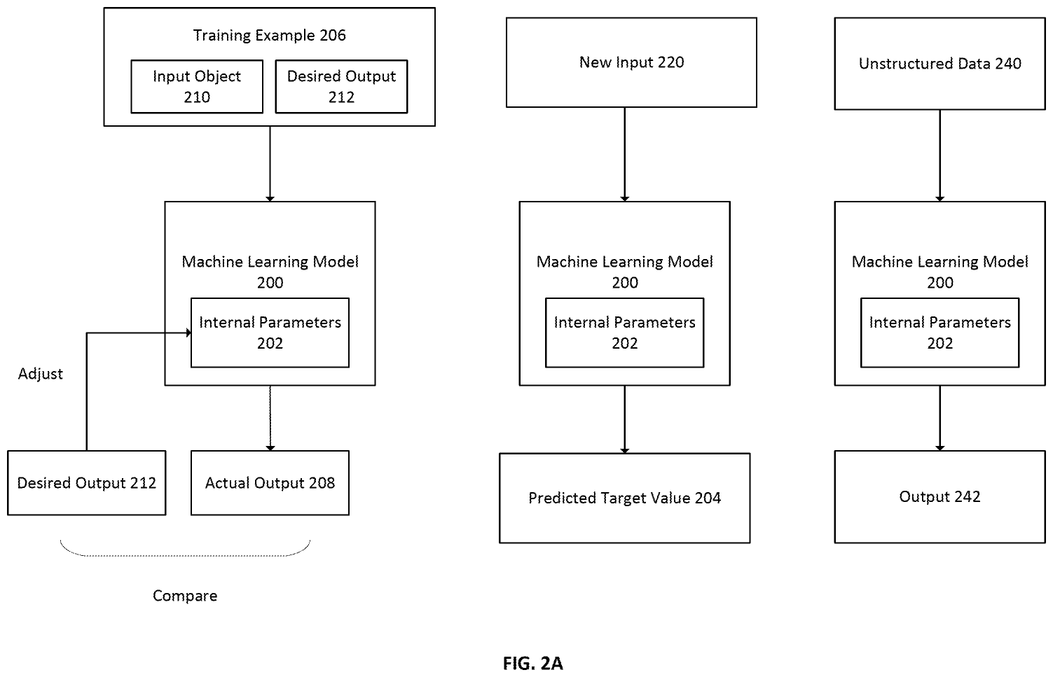

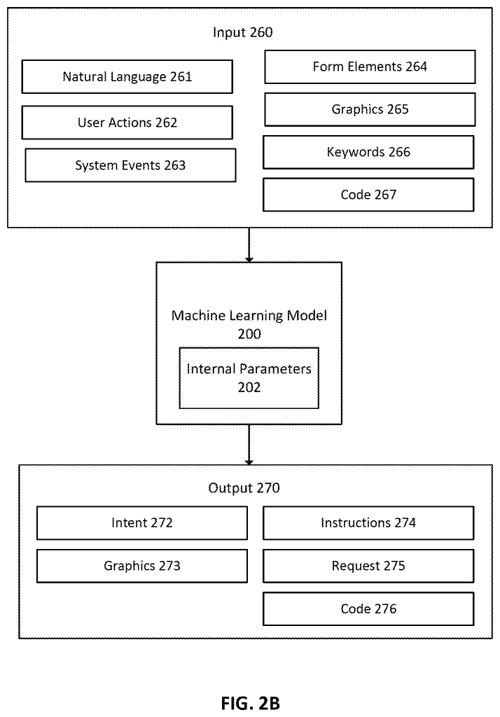

FIG. 2A illustrates an exemplary machine learning model 200. A machine learning model 200 may be a component, module, computer program, system, or algorithm. Some embodiments herein use machine learning for code completion, predictive editing, or predictive navigation. Machine learning model 200 may be used as the model to power those embodiments described herein. In some embodiments, machine learning model 200 uses supervised learning. In such an embodiment, machine learning model 200 is trained with training examples 206, which may comprise an input object 210 and a desired output value 212. The input object 210 and desired object value 212 may be tensors. A tensor is a matrix of n dimensions where n may be any of 0 (a constant), 1 (an array), 2 (a 2D matrix), 3, 4, or more.

The machine learning model 200 has internal parameters that determine its decision boundary and that determine the output that the machine learning model 200 produces. After each training iteration, comprising inputting the input object 210 of a training example in to the machine learning model 200, the actual output 208 of the machine learning model 200 for the input object 210 is compared to the desired output value 212. One or more internal parameters 202 of the machine learning model 200 may be adjusted such that, upon running the machine learning model 200 with the new parameters, the produced output 208 will be closer to the desired output value 212. If the produced output 208 was already identical to the desired output value 212, then the internal parameters 202 of the machine learning model 200 may be adjusted to reinforce and strengthen those parameters that caused the correct output and reduce and weaken parameters that tended to move away from the correct output.

The machine learning model 200 output may be, for example, a numerical value in the case of regression or an identifier of a category in the case of classifier. A machine learning model trained to perform regression may be referred to as a regression model and a machine learning model trained to perform classification may be referred to as a classifier. The aspects of the input object that may be considered by the machine learning model 200 in making its decision may be referred to as features.

After machine learning model 200 has been trained, a new, unseen input object 220 may be provided as input to the model 200. The machine learning model 200 then produces an output representing a predicted target value 204 for the new input object 220, based on its internal parameters 202 learned from training.

Machine learning model 200 may be, for example, a neural network, support vector machine (SVM), Bayesian network, logistic regression, logistic classification, decision tree, ensemble classifier, or other machine learning model. Machine learning model 200 may be supervised or unsupervised. In the unsupervised case, the machine learning model 200 may identify patterns in the unstructured data 240 without training examples 206. Unstructured data 240 is, for example, raw data upon which inference processes are desired to be performed. An unsupervised machine learning model may generate output 242 that comprises data identifying structure or patterns.

A neural network may be comprised of a plurality of neural network nodes, where each node includes input values, a set of weights, and an activation function. The neural network node may calculate the activation function on the input values to produce an output value. The activation function may be a non-linear function computed on the weighted sum of the input values plus an optional constant. In some embodiments, the activation function is logistic, sigmoid, or a hyperbolic tangent function. Neural network nodes may be connected to each other such that the output of one node is the input of another node. Moreover, neural network nodes may be organized into layers, each layer comprising one or more nodes. An input layer may comprise the inputs to the neural network and an output layer may comprise the output of the neural network. A neural network may be trained and update its internal parameters, which comprise the weights of each neural network node, by using backpropagation.

A convolutional neural network (CNN) may be used in some embodiments and is one kind of neural network and machine learning model. A convolutional neural network may include one or more convolutional filters, also known as kernels, that operate on the outputs of the neural network layer that precede it and produce an output to be consumed by the neural network layer subsequent to it. A convolutional filter may have a window in which it operates. The window may be spatially local. A node of the preceding layer may be connected to a node in the current layer if the node of the preceding layer is within the window. If it is not within the window, then it is not connected. A convolutional neural network is one kind of locally connected neural network, which is a neural network where neural network nodes are connected to nodes of a preceding layer that are within a spatially local area. Moreover, a convolutional neural network is one kind of sparsely connected neural network, which is a neural network where most of the nodes of each hidden layer are connected to fewer than half of the nodes in the subsequent layer.

A recurrent neural network (RNN) may be used in some embodiments and is one kind of neural network and machine learning model. A recurrent neural network includes at least one back loop, where the output of at least one neural network node is input into a neural network node of a prior layer. The recurrent neural network maintains state between iterations, such as in the form of a tensor. The state is updated at each iteration, and the state tensor is passed as input to the recurrent neural network at the new iteration.

In some embodiments, the recurrent neural network is a long short-term (LSTM) memory neural network. In some embodiments, the recurrent neural network is a bi-directional LSTM neural network.

A feed forward neural network is another type of a neural network and has no back loops. In some embodiments, a feed forward neural network may be densely connected, meaning that most of the neural network nodes in each layer are connected to most of the neural network nodes in the subsequent layer. In some embodiments, the feed forward neural network is a fully-connected neural network, where each of the neural network nodes is connected to each neural network node in the subsequent layer.

A gated graph sequence neural network (GGSNN) is a type of neural network that may be used in some embodiments. In a GGSNN, the input data is a graph, comprising nodes and edges between the nodes, and the neural network outputs a graph. The graph may be directed or undirected. A propagation step is performed to compute node representations for each node, where node representations may be based on features of the node. An output model maps from node representations and corresponding labels to an output for each node. The output model is defined per node and is a differentiable function that maps to an output.

Neural networks of different types or the same type may be linked together into a sequential or parallel series of neural networks, where subsequent neural networks accept as input the output of one or more preceding neural networks. The combination of multiple neural networks may comprise a single neural network and may be trained from end-to-end using backpropagation from the last neural network through the first neural network.

FIG. 2B illustrates use of the machine learning model 200 to perform inference on input 260 comprising data relevant to a programming co-pilot system 340. Input 260 may comprise any of natural language input 261, user actions 262, system events 263, form elements 264, graphics 265, keywords 266, code 267 or other data. The machine learning model 200 performs inference on the data based on its internal parameters 202 that are learned through training. The machine learning model 200 generates an output 270 comprising information or data relevant to helping a programmer, such as technical assistance intent 272, graphics 273, instructions 274, requests for information 275 and code 276.

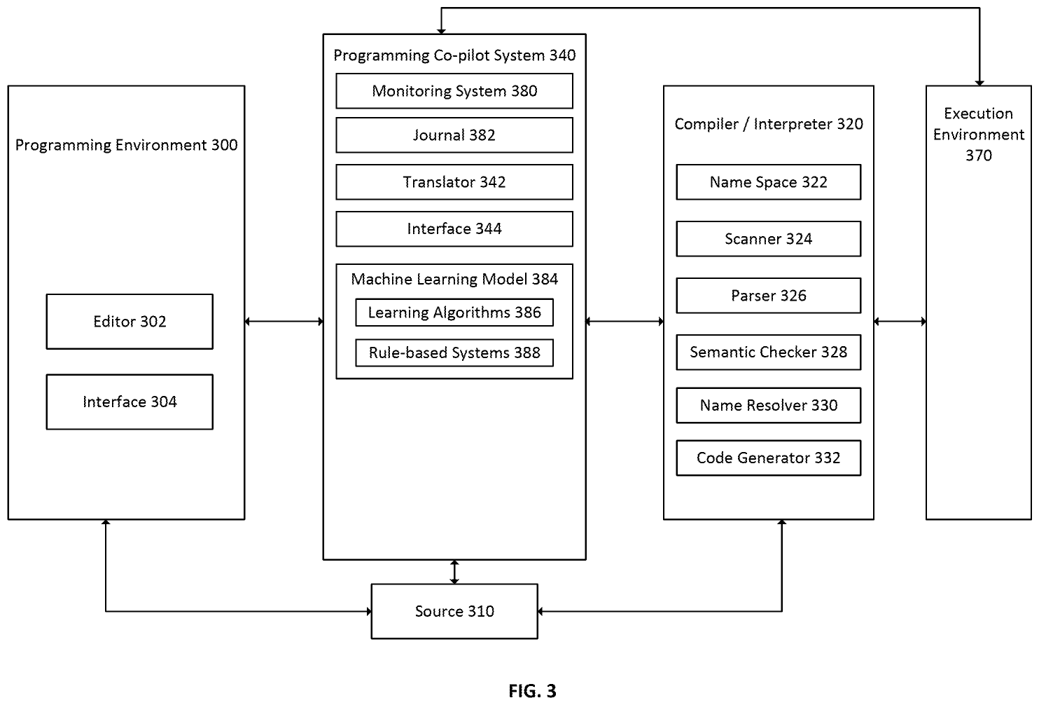

FIG. 3 illustrates an exemplary system for software development. Source code 310 may be provided and edited in a programming environment 300. The programming environment may allow interactive editing of the source code 310 by a user, such as a programmer. A programming environment may include an editor 302 and an interface 304. The editor 302 may provide for the developing, such as writing and editing, of source code 310. The interface 304 may present a human viewable or usable interface for using the editor 302. For example, the interface 304 may comprise a graphical user interface. Many different kinds of editor 302 may be used such as an integrated development environment (IDE), text editor, or command line. In some embodiments, an IDE such as Eclipse, Sublime, Atom, or Visual Studio may be used. In other embodiments, a shell or operating command line such as the Bash command line is used as a programming environment and may comprise an editor 302. In still other embodiments, single input interactive environments, such as Read-Eval-Print Loop (REPL), may be used as the editor 302. The programming environment may also include other running computer applications on the system such as a web browser.

A compiler or interpreter 320 may compile the code 310 into executable instructions or an intermediate representation or interpret the source code 310 for execution. The compiler/interpreter 320 may comprise a namespace 322 that can be used to store symbols, such as identifiers and types, and to allow for name resolution 330. In some embodiments, the compiler/interpreter 320 may comprise a scanner 324, parser 326, semantic checker 328, name resolver 330, and code generator 332. Scanner 324 may accept as input the source code 310 and split expressions and language statements into tokens that can be processed by the parser 326 to determine the grammatical structure of a program. A token may be a single element of a programming language such as a constant, identifier, operator, separator, reserved word, or other element. In some embodiments, a token is atomic and is the smallest semantic unit of a programming language, such that the token cannot be broken down further into units with semantic meaning in the language. The parser 326 may parse the tokens and organize them according to a grammar of a programming language. In some embodiments, parser 326 builds a parse tree. Semantic checker 328 may perform semantic checking of a computer program and may identify and throw errors that are semantic in nature. The name resolver 330 may resolve names in the parse tree to elements of the namespace 322. Code generator 332 may translate the parse tree, or other intermediate representation of the source code, into a target language. The target language may be executable instructions, such as a binary executable, or an intermediate language that may be interpreted for execution. In an execution environment 370, code may be executed, such as for testing or production.

Programming co-pilot system 340 may interact with the programming environment 300, source code 310, compiler/interpreter 320, and execution environment 370 to provide programming assistance to the programmer. Programming co-pilot 340 may include a monitoring system 380 to monitor user actions in a programming environment 300 and editor 302 and system events such as inputs, outputs, and errors. Programming co-pilot 340 may also include a journal 382, which may comprise a digital record of the history of data, such as sequential changes to and versions of source code, user interactions in the editor 302, user interactions in other parts of a system such as a terminal or web browser, system events, and other data. The journal 382 may record data sequentially so that a sequence of events may be exactly reconstructed. Programming co-pilot 340 may include functionalities such as translator 342, technical assistance request interface 344, and other functionalities. Programming co-pilot 340 may include machine learning model 384 to power its functionality, including learning algorithms 386 that learn from data or rule-based systems 388 that use hard-coded rules or heuristics. Although illustrated as one unit, multiple machine learning models 384 may be used in practice to perform or implement different functionality. For example, each function may have a separate machine learning model. Programming co-pilot system 340 may interface with the programming environment 300 through API calls, data streams, inter-process messages, shared data structures, or other methods. In some embodiments, the programming co-pilot 340 is a separate program from the programming environment 300. In other embodiments, the programming co-pilot is a sub-program or component of the programming environment 300.

An embodiment of a programming co-pilot system 340 and its various functionality will be described herein. The programming co-pilot system 340 may include various combinations of the features described herein. In some embodiments, it includes all the functionalities described herein, and, in other embodiments, it includes only a subset of the functionalities described.

Embodiments may operate on any kind of source code including imperative programming languages, declarative code, markup languages, scripting languages. and other code. For example, source code may be Python, Perl, PHP, Javascript, Java, C, C++, HTML, reStructuredText, Markdown, CSS, shell scripts (such as bash, zsh, etc.), and so on.

### A. Natural Language Interface

A smart assistant is disclosed that provides for interfaces to capture requirements for a technical assistance request and then execute actions responsive to the technical assistance request. In use, when a user encounters a task that they wish to automate, the user may first choose an interface through which to define the task or capture requirements of the task. In an embodiment, a natural language interface may be used to capture task requirements from a user. In some embodiments, the natural language interface may include a responsive interface to refine the task requirements gathered from the user. For example, in an embodiment, a conversational natural language chat interface may be provided to refine and clarify the requirements of a task. In another embodiment, a graphical interface may be used to define task requirements.

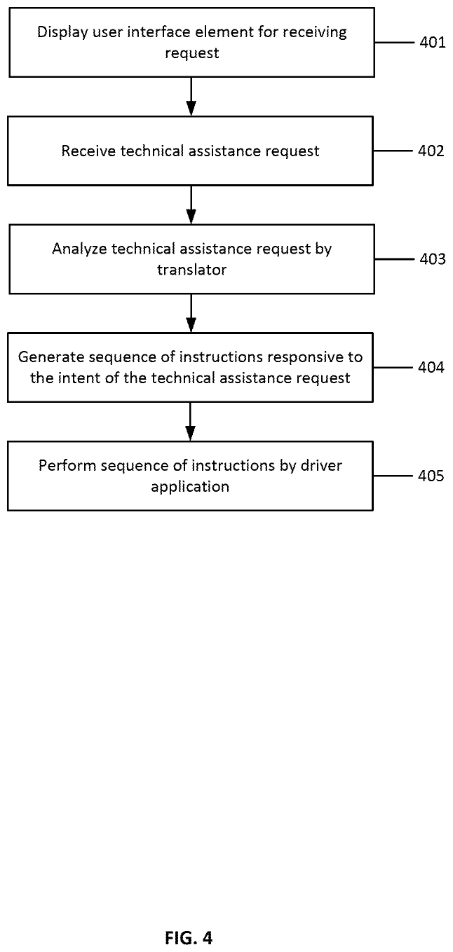

FIG. 4 illustrates the steps of a method for generating computer code in response to a technical assistance request. At step 401, a computer system displays a user interface element for receiving a technical assistance request from a user. In an embodiment, the user interface element may be, for example, a dialog box integrated into a computer program or application that a user requests help with. For example, a programming environment may provide a user interface to receive requests for technical assistance with programming-related tasks. In an embodiment, the user interface may be implemented as an extension, plugin, or add-in to the programming environment. In another embodiment, the user interface may be integrated with an operating system of a computing system and available through the operating system interface regardless of what applications or programs are being run on the computing system. The interface may be able to identify context of a technical assistance request to better provide technical assistance. For example, the interface may detect the language of code being written in or edited by a programming environment.

In some embodiments, the interface may be comprised of a graphical editing interface. The graphical editing interface may be, for example, a WYSIWYG (“what you see is what you get”) editing interface in which graphical and textual content may be edited in a form closely resembling its appearance when printed or displayed as a finished product, such as a printed document, web page, or slide presentation. In some embodiments, the graphical interface may be implemented as a plugin, addon, or extension to a web browser, and the content may be a web page rendered by the web browser defined by markup code in HTML, CSS, and other web page technologies.

At step 402, the computer system receives the technical assistance request task. For example, the technical assistance request may be received in the form of a natural language text query. In some embodiments, the technical assistance request may be comprised of a product specification to implement that documents a desired behavior, operation, or action of a computer program. In some embodiments, the technical assistance request may be comprised of pseudocode, and informal high-level description of the operating principle of a computer program or other algorithm. Pseudocode may use the structural conventions of a programming language but is intended for human reading rather than machine reading. The pseudocode input may omit details that may otherwise be required for an implementation in a given programming language, such as variable declarations, system-specific code, and some subroutines. The pseudocode may be easier for users to understand than conventional programming language code and may not require knowledge of a programming language to write.

In some embodiments, the technical assistance request may be comprised of computer code in a first language, and a target desired output language. For example, the technical assistance request may be code written in the Python language and the target desired output language may be JavaScript.

In some embodiments, the technical assistance request may be comprised of one or more graphical elements or instructions. For example, the technical assistance request may be received from a WYSIWYG editing interface in the form of a series of graphical manipulations to a web page or other rendered or graphical document. In some embodiments, the technical assistance request may be received in the form of an image or graphic defining a desired output. For example, the technical assistance request may be a mockup of a web page, and the technical assistance request may comprise instructions to generate computer code that will generate a web page that has an output similar to the input mockup image.

At step 403, a translator analyses the technical assistance request to determine an intent of the user. In an embodiment, the translator may include a parser which parses the technical assistance request into a series of tokens. Then, a machine learning network such as a neural network may be used to determine an intent of the technical assistance request.

At step 404, the translator generates a sequence of instructions responsive to the intent of the user. In an embodiment, a trained machine learning network such as a neural network may generate a sequence of instructions for satisfying the technical assistance request.

At step 405, a driver application performs the sequence of instructions. In some embodiments, the driver application may control the execution of a plurality of computer applications residing and running on one or more remote computing platforms. For example, the driver application may control the execution of a plurality of server applications on a plurality of server computing systems in a datacenter context. In some embodiments, the sequence of instructions may be a single instruction to execute an application. In these embodiments, the driver application may launch the designated application in response to a technical assistance request. In some embodiments, the driver application controls at least one computer application other than the translator and the driver application. In other embodiments, the driver application may control at least two computer applications, at least three computer applications, or more other than the translator and the driver application.

In an embodiment, the driver application controls the execution of computer applications by using application programming interfaces (APIs) of a computer application. In some embodiments, the driver application controls the execution of computer applications by mimicking human input. For example, the driver application may mimic keyboard and/or mouse inputs to a computer application. In these embodiments, the driver application may receive as input a screen output of a computer application to determine what input to send to the application. For example, the driver application may use a computer vision platform to receive a screen display of a computer application, determine what graphical user interface elements are present in the screen display, and to determine what user interface elements to interact with to control the application.

In an embodiment, the driver application controls the execution of a computer applications by using a machine learning-based driver. For example, a machine learning-based driver may be trained on prior uses of the computer application, including the video frames of the graphical user interface as well as a record of the input to the computer application. The driver application may use optical character recognition to identify words associated with received input. For example, if a user clicks on a button that has the text “open,” the machine learning-based driver may associate the word “open” with the click on that particular button. In this way, the machine learning-based driver may learn the semantic meaning of recorded user interactions with computer applications.

### B. Generating Responses for Additional Information

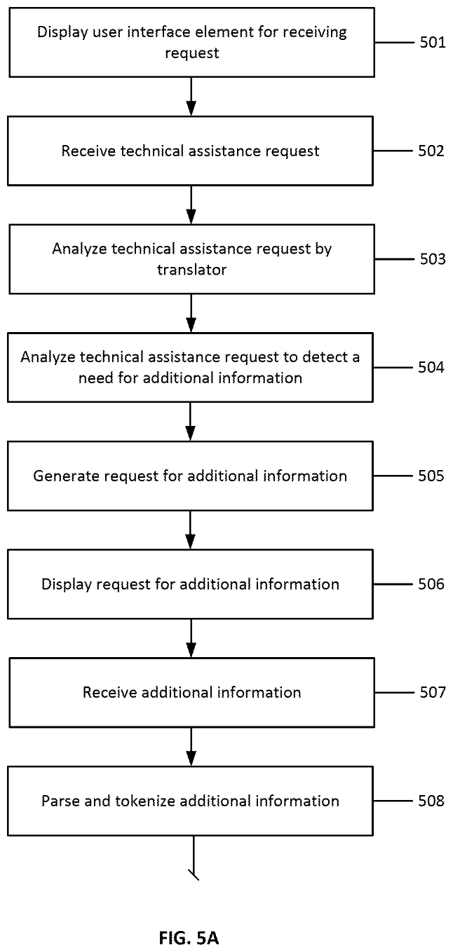

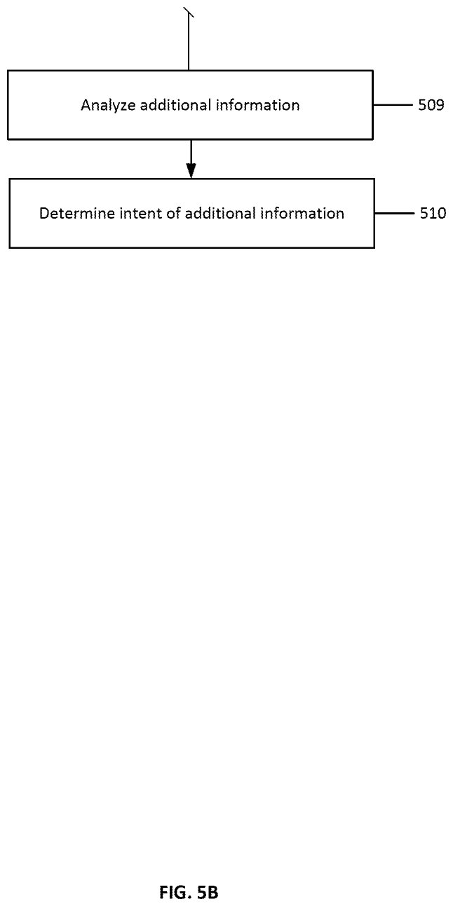

In some embodiments, the smart assistant may identify that it requires further information to respond to a technical assistance request. FIGS. 5A-B illustrate the steps of a method for translating natural language text into a technical assistance request according to an embodiment.

At step 501, a computer system displays a user interface element for receiving a technical assistance request from a user. In an embodiment, the user interface element may be, for example, a dialog box integrated into a computer program or application that a user requests help with. For example, a web browser may provide a user interface to receive requests for technical assistance with the web browser. In an embodiment, the user interface may be implemented as a browser extension to the web browser. In another embodiment, the user interface may be integrated with an operating system of a computing system and available through the operating system interface regardless of what applications or programs are being run on the computing system. The interface may be able to identify a running program or other context of a technical assistance request to better provide technical assistance.

At step 502, the computer system receives the technical assistance request task. For example, the technical assistance request may be received in the form of a natural language text query. The technical assistance request may also be received as a set or series of keywords.

At step 503, a translator parses the technical assistance request into a series of tokens.

At step 504, the parsed and tokenized technical assistance request is analyzed to detect a need for additional information. In an embodiment, a machine learning model may be used to analyze the parsed and tokenized technical assistance request. For example, a machine learning model may identify a technical assistance request template, map the portions of the tokenized technical assistance request to the technical assistance request template, and identify portions of the technical assistance request template that are not mapped to the tokenized technical assistance request. These unmapped portions of the template represent additional information that is required to respond to the technical assistance request.

In an example, if a technical assistance request is initiated by a query “internet not working,” the smart assistant may detect that additional information is required to define the technical assistance request fully. The smart assistant may also request additional information if an original query for a technical assistance request includes a type. In the event of a type or misspelling, the smart assistant may not be able to fully define a technical assistance request and the feedback from a request for more information may indicate to an end user that a typo was present in the original technical assistance request query.

At step 505, an information request is generated in response to identifying additional information required to respond to the technical assistance request. For example, if a portion of a technical assistance request template is unmapped to a portion of the tokenized technical assistance request input, the template may include clarifying questions associated with that portion which may be used to elucidate the missing information.

At step 506, the information request is displayed, and at step 507, additional information is received. For example, the information request may be displayed to a user in the form of a graphical user interface element indicating the type of information required, and the user may type in additional natural language text responsive to the information request in the graphical user interface element.

At step 508, the received additional information is parsed and tokenized. The parsed and tokenized additional information is then analyzed by the machine learning model at step 509 to map the additional information to the original technical assistance request. For example, the additional information may be mapped to the portions of the technical assistance request template that required additional information as previously identified. Additional information may be received when the user has left out some important parameters to the task.

At step 510, the machine learning model determines the intent of the parsed technical assistance request and the parsed additional information. The intent of the parsed technical assistance request and the parsed additional information may then be used to generate a series of instructions responsive to the technical assistance request.

### C. Graphical Request Builder Interface

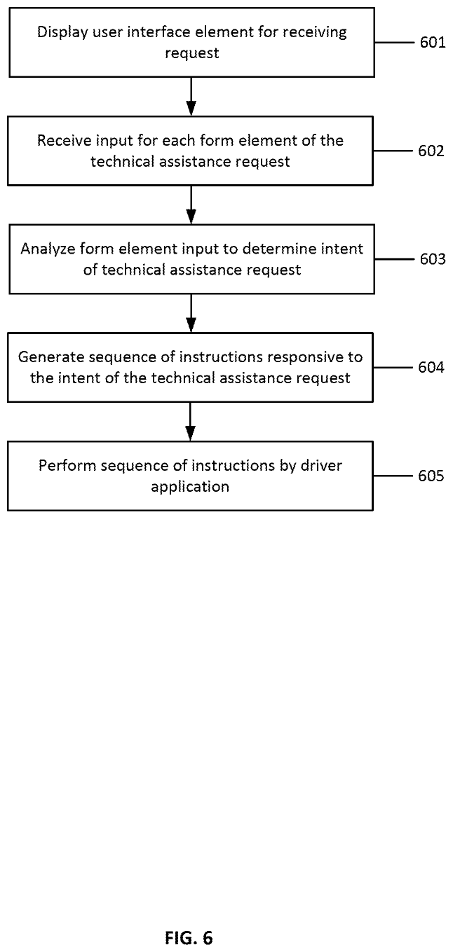

In some embodiments, technical assistance requests may be defined using a graphical user interface request builder to arrange a plurality of visible interface elements for building the technical assistance request. FIG. 6 illustrates the steps of a method for defining a technical assistance request by a request builder to arrange form elements according to an embodiment.

At step 601, a computer system displays a user interface element for receiving a technical assistance request from a user. In an embodiment, the user interface element may be, for example, a dialog box integrated into a computer program or application that a user requests help with. For example, a web browser may provide a user interface to receive requests for technical assistance with the web browser. In an embodiment, the user interface may be implemented as a browser extension to the web browser. In another embodiment, the user interface may be integrated with an operating system of a computing system and available through the operating system interface regardless of what applications or programs are being run on the computing system. The interface may be able to identify a running program or other context of a technical assistance request to better provide technical assistance.

In an embodiment, the user interface may comprise a graphical user interface defining a series of form elements defining the technical assistance request. Form elements may be specific to the context or state of a computing system, such as the open computer applications. Each form element may be comprised of a label and an input field in which to receive information related to the form element. For example, a form element may have a label “I need help with:” and an input field for receiving an indication of what the technical assistance request is related to.

At step 602, the computer system receives input for each form element of the technical assistance request. For example, the input to each form element of the technical assistance request may be received in the form of a natural language text or series of keywords.

At step 603, a translator analyses the form elements of the technical assistance request to determine an intent of the user. In an embodiment, the translator may include a parser which parses the input to each form element of the technical assistance request into a series of tokens. Then, a machine learning network such as a neural network may be used to determine an intent of the form element of the technical assistance request. In some embodiments, additional form elements may be presented to the user to further refine or clarify the technical assistance request. For example, in the example above, a form element may receive the input “internet connection” in connection with the “I need help with” form element. Then, the smart assistant may present a second form element labeled “what would you like to do.” The second form element may receive an input of “reset wireless connection” to further define the technical assistance request, for example.

At step 604, the translator generates a sequence of instructions responsive to the intent of the user. In an embodiment, a trained machine learning network such as a neural network may generate a sequence of instructions for satisfying the technical assistance request. In some embodiments, a sequence of instructions may be generated for each form element of a technical assistance request. In some embodiments, a sequence of instructions may be generated for a plurality of form elements of a technical assistance request.

At step 605, a driver application performs the sequence of instructions. In an embodiment, for example, the driver application may control the execution of one or more computer applications other than the translator and the driver application. For example, the driver application may control the execution of a computer application that originated the technical assistance request. In some embodiments, the driver application controls at least one such computer application other than the translator and the driver application. In other embodiments, the driver application may control at least two computer applications, at least three computer applications, or more other than the translator and the driver application.

Once a technical assistance request has been defined through one of the approaches disclosed above, a driver application implements the technical assistance request by executing the steps of the task in sequence. Below are disclosed several examples of driver applications in various embodiments.

In some embodiments, a technical assistance request may be defined for control of one or more computing systems. For example, in an embodiment, a technical assistance request may define a series of instructions for configuring a single computing system. An example of a single computing system may be, for example, an end user's desktop computing environment. In some embodiments, a technical assistance request may define a series of instructions for two or more computing systems. In some examples, a technical assistance request may configure or control a plurality of desktop computing environments in an enterprise setting, or a technical assistance request may configure or control a plurality of server computing systems in a datacenter to communicate or cooperate with each other in some way. For example, a technical assistance request may configure a high performance computing cluster or a distributed application architecture.

In an example, the smart assistant may be used by a user to set up computing infrastructure even if the user may not know how to do so. In this example, a technical assistance request may comprise a natural language query expressing the user's intent to install and configure web servers, database servers, load balancers, and/or other such infrastructure for some task or environment. The smart assistant may then make the appropriate API calls to provision and configure servers, copy files, code, or data to the servers, and start the appropriate services on the servers to implement the computing infrastructure as detailed in the user's technical assistance request. The smart assistant may further configure the computing environment according to the technical assistance request, for example by configuring automatic scaling or load-balancing behaviors of the computing environment. The smart assistant may be trained on past behavior of users performing similar tasks. In some embodiments, the smart assistant may also be trained on hard-coded behaviors or scripts to implement some behaviors.

### D. Automatic Assistance

In some embodiments, the smart assistant may help the user with a technical assistance request without explicit invocation. In these embodiments, the smart assistant may determine that there is a high likelihood that the user will need to complete a certain task based on the previous actions the user has taken. Then, the smart assistant may automatically generate a technical assistance request based on the user's actions and the computing environment. In some embodiments, the generated technical assistance request may be executed automatically, and in some embodiments the smart assistant may require user authorization prior to executing the technical assistance request. For example, if a user's wireless connection cuts out unexpectedly, the smart assistant may show a dialog box to the user asking if they want help fixing it.

### E.

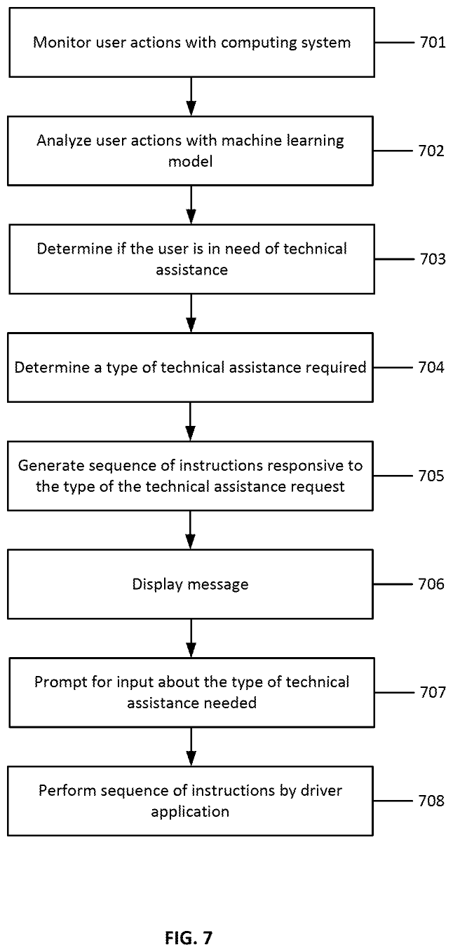

FIG. 7 illustrates the steps of a method for automatically performing a technical assistance request task according to an embodiment. At step 701, a computer system monitors user actions of a computing system. User actions may include, for example, edit actions, navigate actions, and select actions. At step 702, the user actions are analyzed using a machine learning model. In some embodiments, the machine learning model may be a trained neural network, for example.

At step 703, the machine learning model determines, based on the user actions, that the user is in need of technical assistance. The machine learning model may be trained on previously recorded or observed user interactions and invocations of technical assistance requests. For example, if the user above is unable to access the shared network folder, the machine learning model may determine that the user is in need of technical assistance.

At step 704, the machine learning model determines a type of technical assistance needed by the user. At step 705, a translator generates a sequence of instructions responsive to the type of technical assistance needed by the user. At step 706, displaying a message to the user to ask if he needs technical assistance, prior to performing the sequence of instructions. The user may indicate that they do require technical assistance, or that they do not require technical assistance. This response may be used for further training of the machine learning network to further learn when user actions are likely indicative of requiring technical assistance.

At step 707, optionally prompting the user for input about the type of technical assistance needed. The smart assistant may present a conversational interface that accepts natural language responses from the user to further specify the technical assistance request. Any additional information received may be used to modify the sequence of instructions or to append additional instructions to the sequence of instructions.

At step 708, performing, by a driver application, the sequence of instructions, wherein the driver application controls the execution of at least one computer applications, wherein the at least one computer applications are not the translator and not the driver application. In some embodiments, the driver application controls at least two such computer applications other than the translator and the driver application.

In some embodiments, the smart assistant is configured to assist programmers in various coding tasks. For example, the smart assistant may be configured to automatically generate code from a natural language or pseudocode input. Pseudocode may refer to an informal high-level description of the operating principle of a computer program or other algorithm. Pseudocode may be language agnostic, that is, it may describe the intended operation of a computer without direct reference to a specific format, template, language, or rules for organization. Because pseudocode may be language agnostic, a program or segment of code may be written so as to reproduce the logic and functionality described in the pseudocode.

In some embodiments, the smart assistant may be configured to automatically generate code in a first programming language from code written in a second programming language. For example, if a programmer is fluent in a first programming language but has a need to edit a program in a second programming language, the smart assistant may be configured to automatically translate code written in the first language to the second language. Using the smart assistant, then, the programmer may write code in the language they are familiar with while being able to work with code in a language they are unfamiliar with.

### F. Smart Assistant for Generating Computer Code

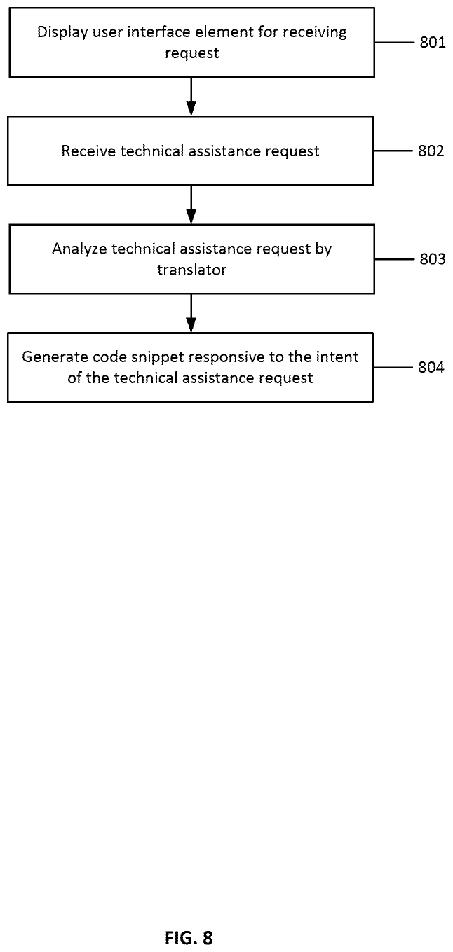

FIG. 8 illustrates the steps of a method for generating computer code from natural language text according to an embodiment. At step 801, a computer system displays a user interface element for receiving a technical assistance request from a user. In an embodiment, the user interface element may be, for example, a dialog box integrated into a computer program or application that a user requests help with. For example, a programming environment may provide a user interface to receive requests for technical assistance with programming-related tasks. In an embodiment, the user interface may be implemented as an extension, plugin, or add-in to the programming environment. In another embodiment, the user interface may be integrated with an operating system of a computing system and available through the operating system interface regardless of what applications or programs are being run on the computing system. The interface may be able to identify context of a technical assistance request to better provide technical assistance. For example, the interface may detect the language of code being written in or edited by a programming environment.

At step 802, the computer system receives the natural language text technical assistance request. For example, the technical assistance request may be received in the form of a natural language text query. In some embodiments, the technical assistance request may be comprised of a product specification to implement that documents a desired behavior, operation, or action of a computer program. For example, if the user needs to implement a new endpoint, a technical assistance request may include requirements of the endpoint such as URLs and the information or data which is accessible at those URLs.

In some embodiments, the technical assistance request may be received in the form of an output of a graphical user interface request builder. For example, the technical assistance request may be comprised of a series of form elements that have been selected and arranged to describe a desired output.

In some embodiments, the technical assistance request may be comprised of pseudocode, and informal high-level description of the operating principle of a computer program or other algorithm. Pseudocode may use the structural conventions of a programming language but is intended for human reading rather than machine reading. The pseudocode input may omit details that may otherwise be required for an implementation in a given programming language, such as variable declarations, system-specific code, and some subroutines. The pseudocode may be easier for users to understand than conventional programming language code and may not require knowledge of a programming language to write.

In some embodiments, the technical assistance request may be comprised of computer code in a first language, and a target desired output language. For example, the technical assistance request may be code written in the Python language and the target desired output language may be JavaScript. In an embodiment, the input code may be code selected in a programming environment, such as by highlighting a segment of code or selecting a file containing code.

A desired target output language may be explicitly specified by a user, such as through a selection in a graphical user interface or implied from a context of the programming environment. For example, if a codebase in a particular programming language was opened in the programming environment, the smart assistant may automatically generate output code responsive to the technical assistance request in that programming language.

At step 803, a translator analyses the technical assistance request to determine an intent of the user. In an embodiment, the translator may include a parser which parses the technical assistance request into a series of tokens. Then, a machine learning network such as a neural network may be used to determine an intent of the technical assistance request. In an embodiment, the series of tokens may be comprised of tokens of an intermediary programming language. In an embodiment, the series of tokens may be a more abstract representation of computer program functionality that is not necessarily executable code.

In some embodiments, the translator may detect a need for additional information and present an information request to receive further information defining the technical assistance request. In an embodiment, a machine learning model may be used to analyze the parsed and tokenized technical assistance request. For example, a machine learning model may identify a technical assistance request template, map the portions of the tokenized technical assistance request to the technical assistance request template, and identify portions of the technical assistance request template that are not mapped to the tokenized technical assistance request. These unmapped portions of the template represent additional information that is required to respond to the technical assistance request. In an embodiment, the translator may present a conversational interface through which additional information in the form of natural language text may be requested from and received from a user.

At step 804, generating, by the translator, a snippet of code in a computer language in a computer language responsive to the intent of the user. For example, if the technical assistance request included a designation that the output be in the CoffeeScript language, the generated code responsive to the technical assistance request would be in the CoffeeScript language.

In some embodiments, the snippet of code may be an incomplete implementation of the desired behavior which a user may further edit to produce a final desired program. For example, the snippet of code may be a “scaffold” or template that defines some structure of the desired program but may be edited or modified by a programmer to achieve a desired functionality.

### G. Smart Assistant for Generating Database Queries

In some embodiments, a technical assistance request may be defined to manipulate a data source. For example, in an embodiment, a technical assistance request may produce a data query such as a SQL query.

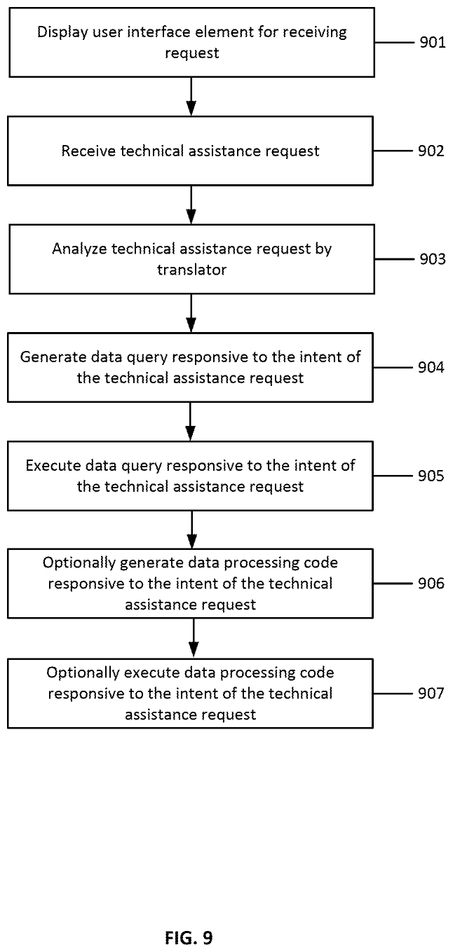

FIG. 9 illustrates the steps of a method for automatically generating a sequence of queries to access a database according to an embodiment. The method may also optionally generate code to operate on the results of the database queries, such as code to perform predictions based on the retrieved data. At step 901, a computer system displays a user interface element for receiving a technical assistance request from a user. In an embodiment, the user interface element may be, for example, a dialog box integrated into a computer program or application that a user requests help with. For example, a programming environment may provide a user interface to receive requests for technical assistance with querying data. In an embodiment, the user interface may be implemented as an extension, plugin, or add-in to the programming environment or a database management environment.

In another embodiment, the user interface may be integrated with an operating system of a computing system and available through the operating system interface regardless of what applications or programs are being run on the computing system. The interface may be able to identify context of a technical assistance request to better provide technical assistance. For example, the interface may detect a database connection based on code present in a programming environment or other context of a programming or database management environment.

At step 902, the computer system receives the database query technical assistance request. In some embodiments, the technical assistance request may be received in the form of a natural language text query. For example, the technical assistance request may be a request to query a data source. The data source may be any kind of data source such as a relational database, non-relational database, file system, or flat file, for example.

In some embodiments, the technical assistance request may be received in the form of an output of a graphical user interface request builder. The technical assistance request may be comprised of a series of form elements that have been selected and arranged to describe a desired output. In an example, the form elements may correspond to portions of a query of a data source or specific functions or units of action related to a data source. For example, in an embodiment, form elements may correspond to Structured Query Language (SQL) constructs such as SELECT, FROM, WHERE, GROUP BY, HAVING, ORDER BY, DISTINCT, LIMIT, and other such SQL syntax. Using a graphical interface, a user may drag and drop form elements in order to formulate a complete technical assistance request.

At step 903, a translator analyses the technical assistance request to determine an intent of the user. In an embodiment, the translator may include a parser which parses the technical assistance request into a series of tokens. Then, a machine learning network such as a neural network may be used to determine an intent of the technical assistance request. In an embodiment, the series of tokens may be comprised of tokens of an intermediary programming language. In an embodiment, the series of tokens may be a more abstract representation of computer program functionality that is not necessarily executable code.

In some embodiments, the technical assistance request may include a request to perform a data modeling function on the data source in conjunction with the data query. The technical assistance request may specify to model a projection of data into the future, or a prediction of future data. For example, a data source may include a time-series of data points and a technical assistance request may include a request to model a forecast of future time values for the data. The smart assistant may use any type of forecasting to generate future predictions, such as regression analysis, trend analysis, curve fitting, extrapolation, or other such prediction modeling techniques. In some embodiments, a machine learning network may be trained on the data to formulate future predictions about the data. A machine learning network may be trained using tuples of natural language input, data sets from data sources, and data modeling techniques. The technical assistance request may further include any assumptions or parameters for the prediction. Examples of assumptions or parameters may include, for example, absolute changes in data, relative changes in data, proportional changes in data, or behavioral models of systems underlying the data in the data source. One example of a parameter may be an interest rate or a month-over-month growth rate of a value of the data source, for example.

In some embodiments, the translator may detect a need for additional information and present an information request to receive further information defining the technical assistance request. In an embodiment, a machine learning model may be used to analyze the parsed and tokenized technical assistance request. For example, a machine learning model may identify a technical assistance request template, map the portions of the tokenized technical assistance request to the technical assistance request template, and identify portions of the technical assistance request template that are not mapped to the tokenized technical assistance request. These unmapped portions of the template represent additional information that is required to respond to the technical assistance request. In an embodiment, the translator may present a conversational interface through which additional information in the form of natural language text may be requested from and received from a user.

At step 904, generating, by the translator, a data query responsive to the intent of the user. For example, the data query may be a SQL query responsive to the intent of the user. At step 905, the data query may be executed on the data source and the results of the data query presented to the user.

At step 906, optionally generating, by the translator, data processing code to perform operations on the data retrieved by the data query. For example, the translator may generate code to perform a prediction task on the data. In some embodiments, this may be a regression or other data fitting or data science task. At step 907, optionally the data processing code may be executed to process the results of the data query and produce a result. For example, processing the results may include performing a prediction task, such as regression. In an example, a data query may be generated in SQL and executed to retrieve results from a database. The translator may then generate Python code for performing linear regression on the returned results to perform a prediction task.

The results of the data query may be presented in a text format, a visual format, or as a set of statistics or metrics calculated from the results of the data query. For example, the results of the data query may be presented in a spreadsheet format with accompanying statistics, graphs, and charts derived from the results of the data query. The automated presentation of data may be also used without performing any data manipulation on the data set. For example, a technical assistance request may only define an intent to automatically calculate summary statistics, graphs, and charts about a data set. Such a technical assistance request may be used, for example, to automatically summarize and present a data source selected by a user.

The smart assistant may automatically determine what statistics, graphs, and charts to compute and present based on the content of a data source. Examples of statistics about data sources may include, for example, averages, means, variance, counts, tallies, and other such statistics about data sources. The types of statistics chosen may be based on the content and type of data in the data source. For example, numeric data may be represented differently than text data. These statistics may be presented in a spreadsheet along with the data source, in a logical location, in a separate spreadsheet, or in a separate interface. The smart assistant may also detect what type of data is in the data source and determine what charts or graphs the generate to summarize and present the data source. For example, the smart assistant may detect that a column of the data contains date and time information, infer that the data is a time series, and then plot a time series chart using the dates as the X-axis. Generated charts and graphs may be presented in a spreadsheet along with the data source, in a logical location, in a separate spreadsheet, or in a separate interface.

### H. Smart Assistant for Generating a Graphical User Interface

In some embodiments, the smart assistant may be configured to assist in creating or editing graphical user interfaces. A graphical user interface allows users to interact with electronic devices through graphical icons and visual indicators. In an example, a graphical user interface may be comprised of a web page or web site rendered in a web browser. A web page or web site rendered in a browser may be defined in a markup language such as HTML, an associated styling language such as CSS, and a language that can run in the browser runtime such as JavaScript. Graphical elements of a web page may also be defined by raster image elements, vector graphic elements, video elements, or scripted user interface behaviors. Raster image elements may be, for example, images stored in a format such as JPEG, PNG, GIF, or the like. Vector graphic elements may be images stored in a format such as SVG or the like. Video elements may be videos stored in a format such as WebM, Ogg container, or MP4 container, and encoded with a codec such as VP8, VP9, Theora, H.264, or the like.

A designer may use an image editing tool to generate the layout or design of a web page. This initial design may be referred to as a mockup, as it generally may not include code to enable interaction or dynamic behaviors of a web page. Designers may create mockup for a web page in a static image format such as one of the raster image formats described above or a specialized file format specific to commercial image editing software such as ADOBE PHOTOSHOP or the like. From this mockup, a programmer may generate a functional and interactive web page that has the same visual elements, layout, and design. The process of generating a functional graphical user interface from a mockup may be a time-consuming task involving breaking up the mockup static image into constituent parts, writing code to mimic the layout and structure of a web page that reproduces the look of the mockup, and then integrating any necessary visual elements of the mockup into the web page to achieve a similar look as the mockup. The end result is a web page defined in a combination or markup language code, style-defining code, visual elements, and any other necessary components to reproduce the look and feel of the mockup. The process of converting a mockup graphical user interface to functional code may be used to make other types of user interfaces as well, such as desktop program graphical user interfaces.

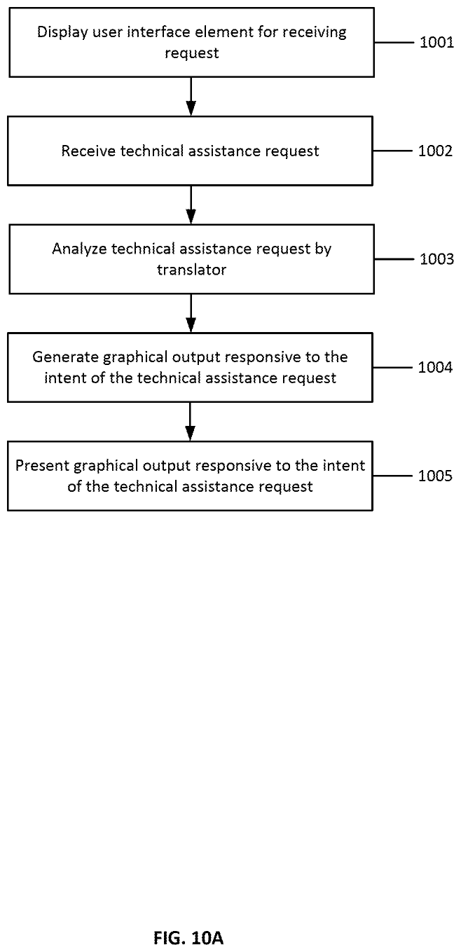

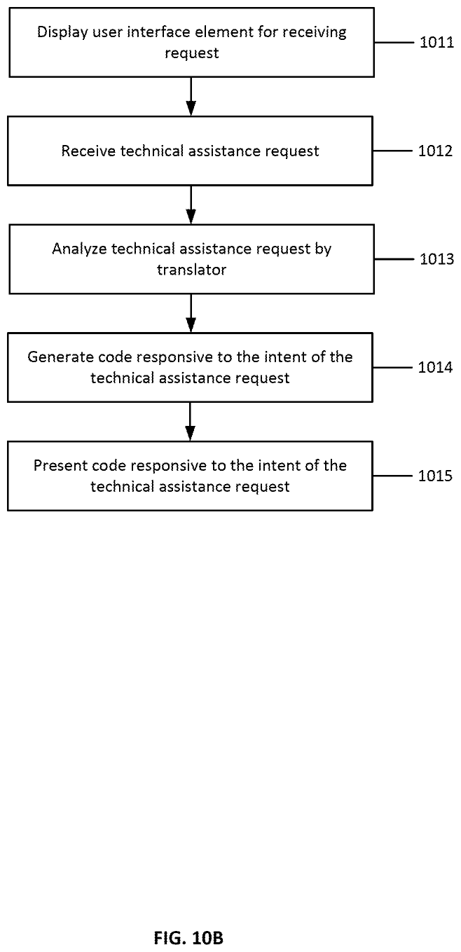

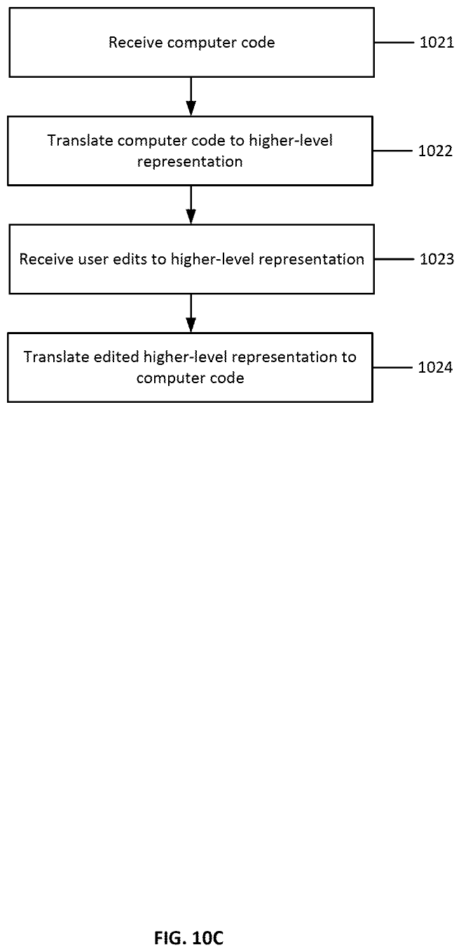

FIG. 10A illustrates the steps of a method for generating a graphical user interface from a mockup according to an embodiment. At step 1001, a computer system displays a user interface element for receiving a technical assistance request from a user. In an embodiment, the user interface element may be, for example, a dialog box integrated into a computer program or application that a user requests help with. For example, a programming environment may provide a user interface to receive requests for technical assistance with programming-related tasks.

In some embodiments, the interface may be comprised of a graphical editing interface. The graphical editing interface may be, for example, a WYSIWYG (“what you see is what you get”) editing interface in which graphical and textual content may be edited in a form closely resembling its appearance when printed or displayed as a finished product, such as a printed document, web page, or slide presentation. In some embodiments, the graphical interface may be implemented as a plugin, addon, or extension to a web browser, and the content may be a web page rendered by the web browser defined by markup code in HTML, CSS, and other web page technologies.

At step 1002, the computer system receives the technical assistance request task. For example, the technical assistance request may be received in the form of a natural language text query. In some embodiments, the technical assistance request may be directly invoked by a user. For example, a user may select a mockup image in a file browser to generate user interface code. The function may be, for example, invoked through a contextual menu in an operating system file browser and labeled “Generate HTML and CSS.”

In some embodiments, the technical assistance request may be comprised of one or more graphical elements or instructions. For example, the technical assistance request may be received from a WYSIWYG editing interface in the form of a series of graphical manipulations to a web page or other rendered or graphical document. In some embodiments, the technical assistance request may be received in the form of an image or graphic defining a desired output. For example, the technical assistance request may be a mockup of a web page, and the technical assistance request may comprise instructions to generate computer code that will generate a web page that has an output similar to the input mockup image.

In some embodiments, the technical assistance request may be comprised of a graphical document and a collection of modifications to the document. For example, the technical assistance request may be comprised of markup of a web page and a collection of instructions of modifications to the web page to be performed. The modifications may be captured through a WYSIWYG editing interface.

In some embodiments, the technical assistance request may include an instruction to generate a plurality of variations of one or more graphical elements. For example, the technical assistance request may include instructions to generate a plurality of variations of a button element. The variations may be generated by a machine learning network trained to optimize for a parameter or quality of the graphical elements. One example machine learning network may be trained to optimize for user engagement, for example. Another example machine learning network may be trained to optimize for aesthetic qualities. For example, a machine learning network may be trained to transform a web page to increase its aesthetic appeal. A machine learning network may be trained to optimize for non-visual qualities. For example, a machine learning network may be trained to optimize graphical elements for performance metrics such as speed in rendering, number of network connections required to render, network latency, or amount of data that needs to be transferred.

In an example, a technical assistance request may include an instruction to generate a plurality of variations for a button, optimizing for user engagement metrics. The smart assistant may then employ a machine learning network that has been trained on graphical element variations and associated user engagement metrics to generate a plurality of variations of the button that are optimized to increase user engagement. Training data may be sourced from the internet, app stores, or from expert designers.

At step 1003, a translator analyses the technical assistance request to determine an intent of the user. In an embodiment, the translator may include a parser which parses the technical assistance request into a series of tokens. Parsing the technical assistance request into tokens may be performed on textual components of the technical assistance request. Optionally, the technical assistance request may alternatively or additionally comprise an image. The image may be analyzed by an image analysis algorithm and one or more features or components extracted. Then, a machine learning network such as a neural network may be used to determine an intent of the technical assistance request. For example, the technical assistance request may include instructions to edit text copy in the document, select and change text, change the color of an element, drag to resize elements, change the color of an element, change dimensions of an element, delete elements from the document or add elements to the document. The editing interface may be implemented as a web browser extension which allows a user to dynamically make changes to a rendered webpage in an embodiment.

At step 1004, the translator generates a graphical output responsive to the intent of the user. In an embodiment, a trained machine learning network such as a neural network may generate a sequence of instructions for satisfying the technical assistance request. The sequence of instructions responsive to the intent of the user may be comprised of markup language source code for the design mock up such as HTML and CSS for a web page, for example. The smart assistant may further present the output in a rendered format to a user so that the user may preview the output at step 1005. In some embodiments, the smart assistant may commit the markup code or code changes to a codebase automatically.

### I. Smart Assistant for Generating Computer Code

In some embodiments, a technical assistance request may be defined to generate computer code. For example, a technical assistance request may be a high-level or natural language description of a desired behavior or result, and the smart assistant may generate computer code corresponding to the high-level or natural language description.

FIG. 10B illustrates the steps of a method for generating computer code from a high-level or natural language description according to an embodiment. At step 1011, a computer system displays a user interface element for receiving a technical assistance request from a user. In an embodiment, the user interface element may be, for example, a dialog box integrated into a computer program or application that a user requests help with. For example, a programming environment may provide a user interface to receive requests for technical assistance with programming-related tasks.

In some embodiments, the interface may be a source code editor or a text input field for receiving textual input from the user. The textual input may be, for example, a high-level description, natural language text, pseudocode, or any other textual depiction. In other embodiments, the input may be graphical such as a flow diagram.

At step 1012, the computer system receives the technical assistance request task. For example, the technical assistance request may be received in the form of a high-level description, natural language text, or pseudocode describing the desired behavior or outcome of the computer code.

At step 1013, a translator analyses the technical assistance request to determine an intent of the user. In an embodiment, the translator may include a parser which parses the technical assistance request into a series of tokens. Parsing the technical assistance request into tokens may be performed on textual components of the technical assistance request. Then, a machine learning network such as a neural network may be used to determine an intent of the technical assistance request. For example, the technical assistance request may comprise text such as “validate inputs X and Y and store the values in the database,” “read all the users from the database and display them in a table,” “calculate the average price of the products in table Z,” or so forth. The translator may analyze the text to determine the intent of the user in order to translate the request into code.

At step 1014, the translator generates computer code responsive to the intent of the user. In an embodiment, a trained machine learning network such as a neural network may generate a sequence of instructions for satisfying the technical assistance request. The sequence of instructions responsive to the intent of the user may be comprised of computer code, such as source code in a programming language. For example, the system may display the generated computer code in a code editor. In some embodiments, the smart assistant may commit the computer code to a codebase automatically. In some embodiments, the smart assistant may interpret or compile the code and execute the code. In other embodiments, the generated computer code may be machine or assembly code.

At step 1015, the code responsive to the intent of the technical assistance request of the user may be presented to the user. For example, the code may be displayed, such as in a code editor, terminal, or other display.

Further embodiments may enable translation from computer code to a higher-level representation and back to computer code. Computer code written in a source code language or machine code may be translated to a higher-level representation, such as natural language text or pseudocode. The higher-level representation may then be edited. The higher-level representation may then be translated back into computer code.

FIG. 10C illustrates the steps of a method for translating computer code into a higher-level representation, receiving edits to the higher-level representation, and translating back into computer code. At step 1021, computer code is received. In one embodiment, the computer code is in the user's code editor and may have been entered by the user or loaded from a file. The computer code may be selected for translation or an entire file, module, or function may be translation. The computer code may be source code or may be machine or assembly code.

At step 1022, a translator translates the computer code into a higher-level representation. In an embodiment, the translation is performed by a machine learning model such as a neural network. The higher-level representation may be in various forms that are more abstracted or more general than the computer code representation itself. The higher-level representation may be, for example, natural language text that summarizes the behavior or result of the computer code, bullet points describing the high-level steps of the computer code, pseudocode, graphical flow diagrams, or so forth.

At step 1023, user edits are received to the higher-level representation. In one embodiment, the higher-level representation is natural language text or pseudocode, and the user edits the natural language text in a text editor. The editing may be on individual characters or words as allowed by the text editor. In one embodiment, the user may edit segments of the higher-level representation, such as selecting certain phrases, bullet points, code portions, or code entities and selecting whether to keep or delete those portions. The edits may be reflected in the displayed higher-level representation, and the editing may be performed in real-time.

At step 1024, the translator may translate the edited higher-level representation into computer code. The newly generated computer code may differ from the initial code to reflect the changes in the higher-level representation, which may affect the purpose, behavior, or desired outcome of the come. The generated computer code may be in the same programming language as the received computer code from step 1021 or may be in a different programming language. The generated computer code may be source code or machine or assembly code. Thus, through use of this method, the user may be enabled to edit existing computer code through edits to a higher-level representation and is not required to edit the computer code itself.

### J. Computing Environment

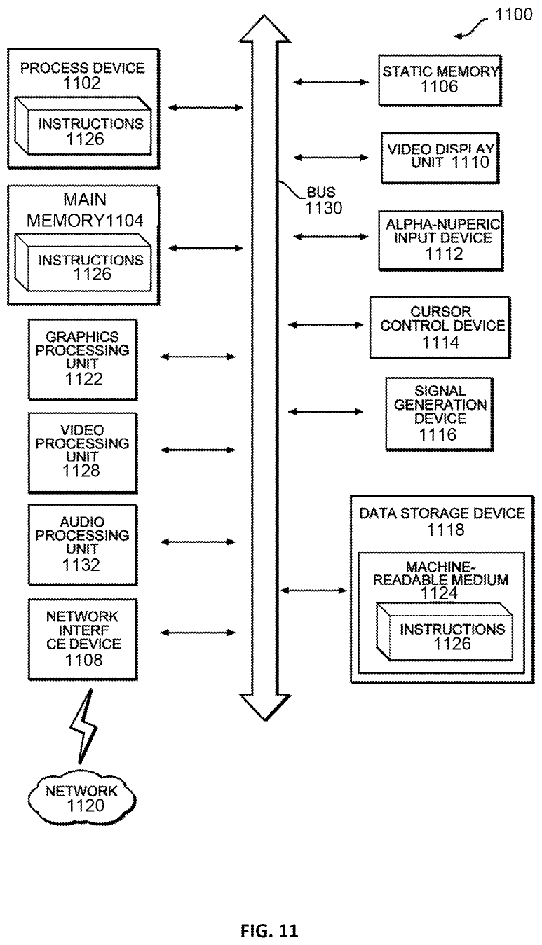

FIG. 11 illustrates an example machine of a computer system within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 1100 includes a processing device 1102, a main memory 1104 (e.g., read-only memory (ROM), flash memory, dynamic random access memory (DRAM) such as synchronous DRAM (SDRAM) or Rambus DRAM (RDRAM), etc.), a static memory 1106 (e.g., flash memory, static random access memory (SRAM), etc.), and a data storage device 1118, which communicate with each other via a bus 1130.

Processing device 1102 represents one or more general-purpose processing devices such as a microprocessor, a central processing unit, or the like. More particularly, the processing device may be complex instruction set computing (CISC) microprocessor, reduced instruction set computing (RISC) microprocessor, very long instruction word (VLIW) microprocessor, or processor implementing other instruction sets, or processors implementing a combination of instruction sets. Processing device 1102 may also be one or more special-purpose processing devices such as an application specific integrated circuit (ASIC), a field programmable gate array (FPGA), a digital signal processor (DSP), network processor, or the like. The processing device 1102 is configured to execute instructions 1126 for performing the operations and steps discussed herein.

The computer system 1100 may further include a network interface device 1108 to communicate over the network 1120. The computer system 1100 also may include a video display unit 1110 (e.g., a liquid crystal display (LCD) or a cathode ray tube (CRT)), an alphanumeric input device 1112 (e.g., a keyboard), a cursor control device 1115 (e.g., a mouse), a graphics processing unit 1122, a signal generation device 1116 (e.g., a speaker), graphics processing unit 1122, video processing unit 1128, and audio processing unit 1132.

The data storage device 1118 may include a machine-readable storage medium 1124 (also known as a computer-readable medium) on which is stored one or more sets of instructions or software 1126 embodying any one or more of the methodologies or functions described herein. The instructions 1126 may also reside, completely or at least partially, within the main memory 1104 and/or within the processing device 1102 during execution thereof by the computer system 1100, the main memory 1104 and the processing device 1102 also constituting machine-readable storage media.

In one implementation, the instructions 1126 include instructions to implement functionality corresponding to the components of a device to perform the disclosure herein. While the machine-readable storage medium 1124 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Various general purpose systems may be used with programs in accordance with the teachings herein, or it may prove convenient to construct a more specialized apparatus to perform the method. The structure for a variety of these systems will appear as set forth in the description below. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

A number of embodiments have been described. Nevertheless, it will be understood that various modifications may be made without departing from the spirit and scope of the invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

What is claimed is:

1. A computer-implemented method comprising:
receiving, by a computer system, a technical assistance request from a user;
analyzing, by a translator, the technical assistance request to determine an intent of the user, wherein the technical assistance request comprises a request to generate computer code;
generating or modifying, by the translator, computer code responsive to the intent of the user.

2. The computer-implemented method of claim 1 further comprising:
translating by the translator the computer code to a high-level representation;
receiving edits to the high-level representation;
generating updated computer code based on the edited high-level representations.

3. The computer-implemented method of claim 2, wherein the high-level representation comprises natural language text.

4. The computer-implemented method of claim 1 further comprising:
receiving the technical assistance request in the form of natural language text;
parsing, by a parser, the technical assistance request into tokens; and
determining the intent of the user from the parsed technical assistance request using a machine learning model.

5. The computer-implemented method of claim 4, wherein the machine learning model is a neural network.

6. The computer-implemented method of claim 1, further comprising displaying a user interface element comprising a graphical user interface (GUI) request builder, wherein the GUI request builder includes a plurality of visible interface elements for building the technical assistance request.

7. The computer-implemented method of claim 1 further comprising:
receiving the technical assistance request in the form of an image;
analyzing, by an image analysis program, the technical assistance request and extracting one or more features;
determining the intent of the user from the analyzed technical assistance request using a machine learning model; and
wherein the computer code implements at least a portion of a graphical user interface.

8. The computer-implemented method of claim 1 further comprising:
receiving the technical assistance request in the form of natural language text;
parsing, by a parser, the technical assistance request into tokens;
analyzing the parsed technical assistance request with a machine learning model and detecting a need for additional information;
generating an information request;
displaying the information request to the user;
receiving additional information from the user;
analyzing the additional information; and
determining the intent of the user from the parsed technical assistance request and the additional information using the machine learning model.

9. The computer-implemented method of claim 1, further comprising executing the computer code.

10. The computer-implemented method of claim 1, further comprising:
wherein the technical assistance request is a request to query a database; and
automatically generating a sequence of queries to access the database according to the technical assistance request.

11. The computer-implemented method of claim 1, further comprising:
wherein the technical assistance request comprises a request to perform a prediction task;
automatically generating a sequence of queries to access a database according to the technical assistance request;
executing the sequence of queries to retrieve data from the database;
automatically performing the prediction task.

12. The computer-implemented method of claim 1, further comprising:
wherein the technical assistance request comprises a request to generate markup language source code from a design mock up;
analyzing the design mock up using a machine learning model; and
generating by the machine learning model the markup language source code for the design mock up.

13. A computer-implemented method comprising:
monitoring, by a computer system, user actions;
analyzing the user actions using a machine learning model;
determining, by the machine learning model based on the user actions, that the user is in need of technical assistance;
determining that the technical assistance needed comprises generating computer code;
generating or modifying, by a translator, computer code responsive to the type of technical assistance needed by the user.

14. The computer-implemented method of claim 13, further comprising displaying a message to the user to ask if technical assistance is needed.

15. The computer-implemented method of claim 14, further comprising prompting the user for input about the type of technical assistance needed.

16. The computer-implemented method of claim 13, further comprising executing the computer code.

17. The computer-implemented method of claim 13, further comprising:
translating by the translator the computer code to a high-level representation;
receiving edits to the high-level representation;
generating updated computer code based on the edited high-level representation.

18. The computer-implemented method of claim 17, high-level representation comprises natural language text.

19. The computer-implemented method of claim 13, further comprising:
receiving the technical assistance request in the form of an image;
analyzing, by an image analysis program, the technical assistance request and extracting one or more features;
determining the intent of the user from the analyzed technical assistance request using a machine learning model; and
wherein the computer code implements at least a portion of a graphical user interface.

20. The computer-implemented method of claim 13, further comprising:
wherein the technical assistance request is a request to query a database; and
automatically generating a sequence of queries to access the database according to the technical assistance request.
